(19) United States
(12) Patent Application Publication
(10) Pub. No.: US 2025/0061881 A1
(43) Pub. Date: Feb. 20, 2025

(54) INTERACTIVE KARAOKE APPLICATION FOR VEHICLES

(71) Applicant: CERENCE OPERATING COMPANY, Burlington, MA (US)

(72) Inventors: Meik PFEFFINGER, Aachen (DE); Markus BUCK, Aachen (DE); Tim HAULICK, Aachen (DE); Stefan HAMERICH, Aachen (DE); Caitlin VACHON, Montreal (CA); Yitshak Lior BEN GIGI, Montreal (CA)

(21) Appl. No.: 18/724,103

(22) PCT Filed: Dec. 29, 2022
(86) PCT No.: PCT/US2022/054266

§ 371 Date: Jun. 25, 2024

Related U.S. Application Data
(60) Provisional application No. 63/295,022, filed on Dec. 30, 2021.

(51) Int. Cl. G10K 15/04; G06F 3/16; G10L 21/0272

(52) U.S. Cl. CPC G10K 15/04; G06F 3/165; G10L 21/0272

(57) ABSTRACT

A system for interactive and iterative media generation may include loudspeakers configured to play back audio signals into an environment, the audio signals including karaoke content; at least one microphone configured to receive microphone signals indicative of sound in the environment; and a processor programmed to receive a first microphone signal from the at least one microphone, the first microphone signal including a first user sound and karaoke content, instruct the loudspeakers to play back the first microphone signal, receiving a second microphone signal from the at least one microphone, the second microphone signal including the first user sound of the first microphone signal and a second user sound, transmitting the second microphone signal, including the first and second microphone signals and the karaoke content, as an instance of iteratively-generated media content.

### CROSS-REFERENCE TO RELATED APPLICATIONS

This application claims the benefit of U.S. provisional application Ser. No. 63/295,022, filed Dec. 30, 2021, the disclosure of which is hereby incorporated in its entirety by reference herein.

### TECHNICAL FIELD

Aspects of the disclosure generally relate to interactive karaoke applications for vehicles.

### BACKGROUND

Modern vehicle multimedia systems often comprise vehicle interior communication (voice processor) systems, which can improve the audio and infotainment options for users. Vehicles are including more and more entertainment applications in order to accommodate passenger desires during long journeys in a vehicle. As vehicle occupants often sing along with the radio, or other media, karaoke systems may be provided within the vehicle as one entertainment application. However, advanced karaoke features may be further desired.

### SUMMARY

A system for interactive and iterative media generation may include loudspeakers configured to play back audio signals into an environment, the audio signals including karaoke content; at least one microphone configured to receive microphone signals indicative of sound in the environment; and a processor programmed to receive a first microphone signal from the at least one microphone, the first microphone signal including a first user sound and karaoke content, instruct the loudspeakers to play back the first microphone signal, receiving a second microphone signal from the at least one microphone, the second microphone signal including the first user sound of the first microphone signal and a second user sound, transmitting the second microphone signal, including the first and second microphone signals and the karaoke content, as an instance of iteratively-generated media content.

A method for interactive and iterative media generation between vehicles may include receiving a first microphone signal from at least one microphone at a first vehicle, the first microphone signal including a first user sound and karaoke content, transmitting the first microphone signal to a second vehicle, receiving a second microphone signal from the second vehicle, the second microphone signal including the first user sound of the first microphone signal and a second user sound, and transmitting the second microphone signal, including the first and second microphone signals and the karaoke content, as an instance of iteratively-generated media content.

A system for sound signal processing in a vehicle multimedia system, may include loudspeakers configured to play back audio signals into an environment, the audio signals including karaoke content, at least one microphone configured to receive microphone signals indicative of sound in the environment, at least one vehicle opening having a powered closure mechanism, and processor programed to receive a microphone signal from the at least one microphone, and in response to a determination that the microphone signal includes occupant voice content, instruct the powered closure mechanism to move the at least one vehicle opening to a closed position.

### BRIEF DESCRIPTION OF THE DRAWINGS

FIG. 1 illustrates a block diagram for a vehicle audio and voice assistant system in an automotive application having a processing system in accordance with one embodiment;

FIG. 2 illustrates an example vehicle karaoke system;

FIG. 3 illustrates an example vehicle-to-vehicle system, each including the karaoke system of FIG. 2; and

FIG. 4 illustrates an example portion of a multichannel sound system within a vehicle; and

FIG. 5 illustrates an example process for the karaoke system.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

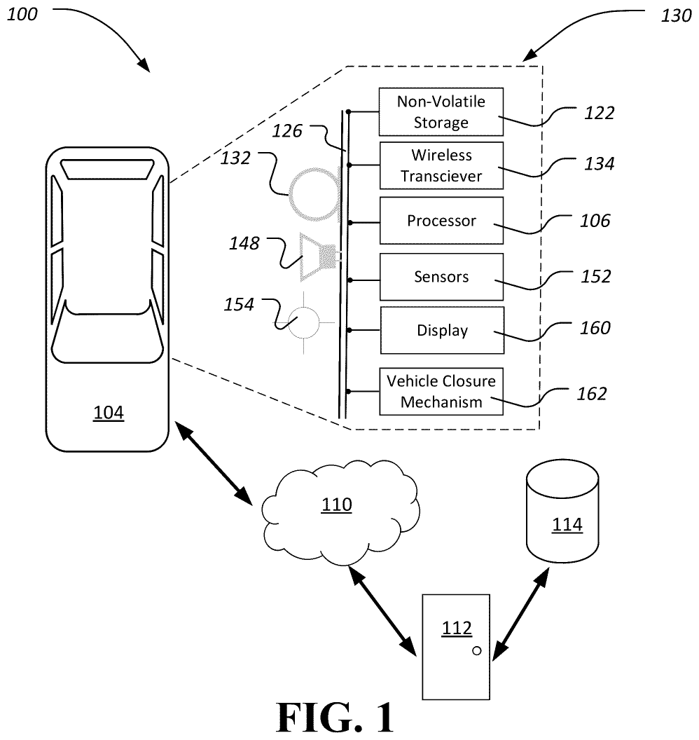

FIG. 1 illustrates a block diagram for an automotive voice assistant system 100 having a multimodal input processing system in accordance with one embodiment. The automotive voice assistant system 100 may be designed for a vehicle 104 configured to transport passengers. The vehicle 104 may include various types of passenger vehicles, such as crossover utility vehicle (CUV), sport utility vehicle (SUV), truck, recreational vehicle (RV), boat, plane or other mobile machine for transporting people or goods. Further, the vehicle 104 may be autonomous, partially autonomous, self-driving, driverless, or driver-assisted vehicles. The vehicle 104 may be an electric vehicle (EV), such as a battery electric vehicle (BEV), plug-in hybrid electric vehicle (PHEV), hybrid electric vehicle (HEVs), etc.

The vehicle 104 may be configured to include various types of components, processors, and memory, and may communicate with a communication network 110. The communication network 110 may be referred to as a “cloud” and may involve data transfer via wide area and/or local area networks, such as the Internet, Global Positioning System (GPS), cellular networks, Wi-Fi, Bluetooth, etc. The communication network 110 may provide for communication between the vehicle 104 and an external or remote server 112 and/or database 114, as well as other external applications, systems, vehicles, etc. This communication network 110 may provide navigation, music or other audio, program content, marketing content, internet access, speech recognition, cognitive computing, artificial intelligence, to the vehicle 104.

In one example, the communication network 110 may allow for vehicle-to-vehicle communication. In the example of a karaoke system, karaoke recordings may be stored and transmitted to other vehicles via the communication network 110, as well as other mediums, such as social media, etc. The occupants of different vehicles may thus share, as well as iteratively create karaoke content by sharing and adding to the karaoke content.

A processor 106 may instruct loudspeakers 148 to playback various audio streams, and specific configurations. For example, the user may request that the playback be of a specific song with only the instrumental track being played. Other options include additionally also including the lead vocals track in the playback. In another option, the playback may include the instrumental track as well as a playback of the user's recorded lead vocals.

When a user or occupant wishes to obtain lyric information about a song, the user may utter a command. The processor 106 may locate lyrics and instruct a display 150 to present the lyrics to the user. Lyric information may be acquired either by querying a database for lyric information, or by recognizing speed uttered during the audio stream from the karaoke content. Lyrics may be output to end users, as well as displayed on the display 150. A text to speech module (not separately illustrated), may be used to generate synthetic speech when necessary. The system may also include speech interfaces, which includes a speech recognition system and natural language understanding system, each to identify words or phrases and aid in interpretating an utterance. Artificial intelligence may be used to continually refine and replicate certain scenarios and processes herein.

The remote server 112 and the database 114 may include one or more computer hardware processors coupled to one or more computer storage devices for performing steps of one or more methods as described herein and may enable the vehicle 104 to communicate and exchange information and data with systems and subsystems external to the vehicle 104 and local to or onboard the vehicle 104. The vehicle 104 may include one or more processors 106 configured to perform certain instructions, commands and other routines as described herein. Internal vehicle networks 126 may also be included, such as a vehicle controller area network (CAN), an Ethernet network, and a media oriented system transfer (MOST), etc. The internal vehicle networks 126 may allow the processor 106 to communicate with other vehicle 104 systems, such as a vehicle modem, a GPS module and/or Global System for Mobile Communication (GSM) module configured to provide current vehicle location and heading information, and various vehicle electronic control units (ECUs) configured to corporate with the processor 106.

The processor 106 may execute instructions for certain vehicle applications, including navigation, infotainment, climate control, etc. Instructions for the respective vehicle systems may be maintained in a non-volatile manner using a variety of types of computer-readable storage medium 122. The computer-readable storage medium 122 (also referred to herein as memory 122, or storage) includes any non-transitory medium (e.g., a tangible medium) that participates in providing instructions or other data that may be read by the processor 106. Computer-executable instructions may be compiled or interpreted from computer programs created using a variety of programming languages and/or technologies, including, without limitation, and either alone or in combination, Java, C, C++, C#, Objective C, Fortran, Pascal, Java Script, Python, Perl, and PL/structured query language (SQL).

The processor 106 may also be part of a processing system 130. The processing system 130 may include various vehicle components, such as the processor 106, memories, sensors, input devices, displays, etc. The processing system 130 may include one or more input and output devices for exchanging data processed by the processing system 130 with other elements shown in FIG. 1. Certain examples of these processes may include navigation system outputs (e.g., time sensitive directions for a driver), incoming text messages converted to output speech, vehicle status outputs, and the like, e.g., output from a local or onboard storage medium or system. In some embodiments, the processing system 130 provides input/output control functions with respect to one or more electronic devices, such as a heads-up-display (HUD), vehicle display, and/or mobile device of the driver or passenger, sensors, cameras, etc.

The vehicle 104 may include a wireless transceiver 134, such as a BLUETOOTH module, a ZIGBEE transceiver, a Wi-Fi transceiver, an IrDA transceiver, a radio frequency identification (RFID) transceiver, etc.) configured to communicate with compatible wireless transceivers of various user devices, as well as with the communication network 110.

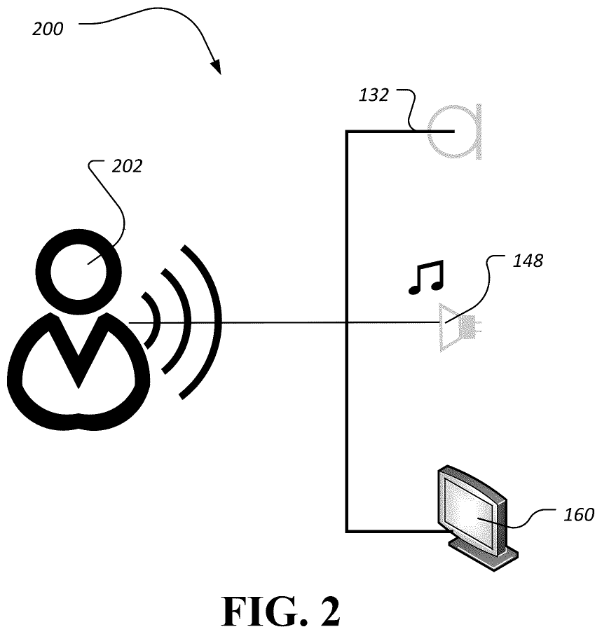

The vehicle 104 may include various sensors and input devices as part of the multimodal processing system 130. For example, the vehicle 104 may include at least one microphone 132. The microphone 132 may be configured receive audio signals from within the vehicle cabin, such as acoustic utterances including spoken words, phrases, or commands from a user. The microphone 132 may also be configured to receive other acoustic sounds such as singing, tapping, knocking, etc. This may be part of a karaoke system 200 as described in FIG. 2. The microphone 132 may also include an audio input configured to provide audio signal processing features, including amplification, conversions, data processing, etc., to the processor 106.

The sensor may include status sensors for various vehicle components such as windows, doors, etc. These sensors may provide status data from the openings indicating, e.g., whether a window is open or closed.

The vehicle 104 may include at least one microphone 132 arranged throughout the vehicle 104. While the microphone 132 is described herein as being used for purposes of the processing system 130 and karaoke system 200, the microphone 132 may be used for other vehicle features such as active noise cancelation, hands-free interfaces, etc. The microphone 132 may facilitate speech recognition from audio received via the microphone 132 according to grammar associated with available commands, and voice prompt generation. The at least one microphone 132 may include a plurality of microphones 132 arranged throughout the vehicle cabin.

The microphone 132 may be configured to receive audio signals from the vehicle cabin. These audio signals may include occupant utterances, sounds, singing, percussion noises, etc. The processor 106 may receive these audio signals and use various ones of these signals to perform looping functions of the karaoke system 200.

The sensors may include at least one camera configured to provide for facial recognition of the occupant(s). The camera may also be configured to detect non-verbal cues as to the driver's behavior such as the direction of the user's gaze, user gestures, etc. The camera may monitor the driver head position, as well as detect any other movement by the user, such as a motion with the user's arms or hands, shaking of the user's head, etc. In the example of a camera, the camera may provide imaging data taken of the user to indicate certain movements made by the user. The camera may be a camera capable of taking still images, as well as video and detecting user head, eye, and body movement. The camera may include multiple cameras and the imaging data may be used for qualitative analysis. For example, the imaging data may be used to determine if the user is looking at a certain location or vehicle display. Additionally or alternatively, the imaging data may also supplement timing information as it relates to the user motions or gestures.

The vehicle 104 may include an audio system having audio playback functionality through vehicle loudspeakers 148 or headphones. The audio playback may include audio from sources such as a vehicle radio, including satellite radio, decoded amplitude modulated (AM) or frequency modulated (FM) radio signals, and audio signals from compact disc (CD) or digital versatile disk (DVD) audio playback, streamed audio from a mobile device, commands from a navigation system, etc. The loudspeakers 148 may also play music for the karaoke system 200, as well as continuously loop the karaoke signals a discussed herein.

As explained, the vehicle 104 may include various displays 160 and user interfaces, including HUDs, center console displays, steering wheel buttons, etc. Touch screens may be configured to receive user inputs. Visual displays may be configured to provide visual outputs to the user. In one example, the display 160 may provide lyrics or other information relevant to the karaoke system, to the vehicle occupant.

The vehicle 104 may include other sensors such as at least one sensor 152. This sensor 152 may be another sensor in addition to the microphone 132, data provided by which may be used to aid in detecting occupancy, such as pressure sensors within the vehicle seats, door sensors, cameras etc. This occupant data from these sensors may be used in combination with the audio signals to determine the occupancy, including the number of occupants.

The vehicle 104 may include at least one interior light 154. The interior light may be dome lights, light emitting diode strip lights, multicolor ambient lighting, etc. The light 154 may be arranged in the center console, floors, dash, foot wells, ceiling, etc. In some examples, the light 154 may adjust based on certain audio signals. For example, the light may be configured to flash, or change colors with the beat of music, specifically music provided by the karaoke system 200. The processor 106 may instruct such lighting changes in response to determining that an audio signal includes karaoke content, or voice/singing content from the user.

The vehicle 104 may also include various openings having powered closure mechanisms 162, such as windows, moonroofs, sunroofs, doors, hatches, etc., that may move from an open position to a closed position. The processor 106 may control powered closure mechanisms 162, and, in addition to user input, may selectively close any open windows, moonroofs, sunroofs, doors, hatches, etc. in response to an indication that a vehicle occupant is participating in karaoke. This may avoid embarrassment for the user, or disturbances to persons outside of the vehicle. The acoustic environment may also be better understood when the windows or other vehicle openings are closed, allowing for better and more optimal signal processing.

As explained above, the sensors may include status sensors for various vehicle components such as windows, doors, etc. These sensors may provide status data from the openings indicating whether a window is open or closed.

The opening and related vehicle closure mechanism 162 may also be associated with a certain seat location or occupant. That is, a driver's side window may be associated with the driver, a passenger's side window may be associated with the passenger, and so on. The processor 106 may control the associated closure mechanism 162 based on a determination of who is participating in karaoke. This may be determined based on any number of inputs and signals such as which microphone picks up the occupants' voice, the occupant's mobile device, etc.

While not specifically illustrated herein, the vehicle 104 may include numerous other systems such as GPS systems, human-machine interface (HMI) controls, video systems, etc. The processing system 130 may use inputs from various vehicle systems, including the loudspeaker 148 and the sensors 152. For example, the multimodal processing system 130 may determine whether an utterance by a user is system-directed (SD) or non-system directed (NSD). SD utterances may be made by a user with the intent to affect an output within the vehicle 104 such as a spoken command of “turn on the music.” A NSD utterance may be one spoken during conversation to another occupant, while on the phone, or speaking to a person outside of the vehicle. These NSDs are not intended to affect a vehicle output or system. The NSDs may be human-to-human conversations. In some examples, a wake up word may be used during live playback of a singer's voice. In this case the processor 106 may provide in car communications (ICC) and/or voice assistant functionality without the utterance being affected by voice effects or voice filters that are applied for karaoke.

While an automotive system is discussed in detail here, other applications may be appreciated. For example, similar functionally may also be applied to other, non-automotive cases, e.g., for augmented reality or virtual reality cases with smart glasses, phones, eye trackers in living environment, etc. While the terms “user” is used throughout, this term may be interchangeable with others such as speaker, occupant, etc.

FIG. 2 illustrates an example vehicle karaoke system 200. The karaoke system 200 may be part of a vehicle multimedia system. The system 200 may include the microphone 132 configured to receive audio signals from a vehicle occupant, such as singing, for example. The singing of the passenger 202 is recorded by a microphone 132 and played back via loudspeakers 148. The display 160 may present information to the passenger 202, such as text streams of lyrics. The passenger 202 reads the text of the song which he is singing from the display 160. The display 160 may, for example, be mounted in a headrest or in the dashboard. The karaoke system 200 may concurrently play the audio content or music via the loudspeakers 148. Additionally, the system 200 may also concurrently output the singing of the passenger 202. The karaoke system 200 may further include all the features of various karaoke systems. Multiple microphones 132 may be provided so that multiple passengers may sing simultaneously, or a music video may be shown together with the text of the song on the display 160.

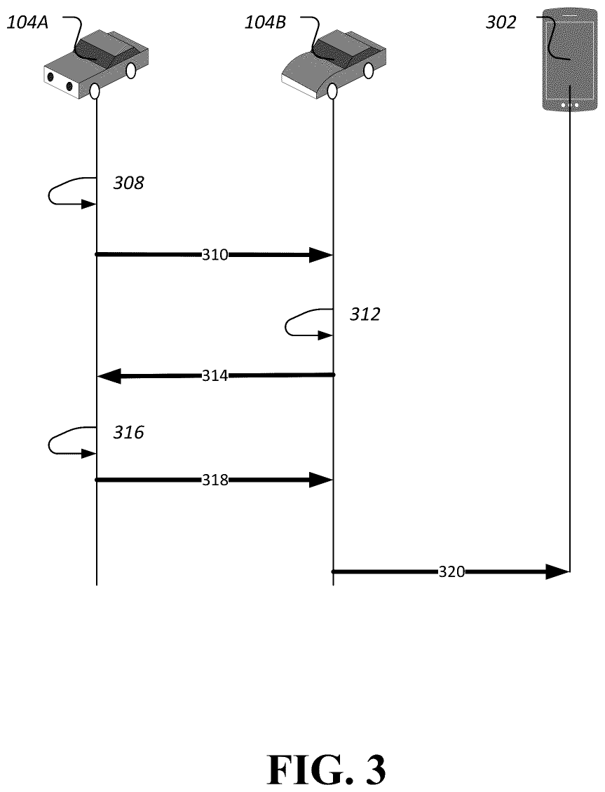

FIG. 3 illustrates an example process 300 for the karaoke system of FIG. 2, where the system 200 allows for vehicle to vehicle sharing of karaoke content. This may allow for a looper function where the audio signal of a Karaoke performance may be stored and replayed in the vehicle. A vehicle occupant may then sing on top of the audio signal and add a new voice track or other sounds such as rhythmic sounds like snipping, tapping on the steering wheel, knocking on the dashboard, etc. By repeating this overdubbing, the occupant or occupants may create a polyphonal recording with voice and rhythmic elements. While FIG. 3 illustrates multiple vehicles, the looping function may be appreciated by a single occupant within a single vehicle. The resultant karaoke recording may be shared with others via social media, etc.

In the example process 300, a first vehicle 104A may have at least one first occupant and a second vehicle 104B may have at least one second occupant. The first occupant may generate a first karaoke signal at 308. This may include, in one example, the occupant singing along to a track and recording the track. This recording may be transmitted at 310 to the second vehicle 104B and the second occupant may overdub on this recording creating a second recording at 312. This overdub may add rhythmic or percussion sounds created by the second user, such as tapping the steering wheel or clapping hands, etc. Additionally or alternatively, the second occupant may add more voice tracks to the content.

At 314, the second recording is transmitted back to the first vehicle 104A where the first occupant may once again add an overdubbed sound to the recording. This iterative looping may allow for an interactive, social, and entertaining karaoke option for the vehicles and their occupants. At 318, the first occupant may share the third iteration of the recording with the second vehicle 104B. The second occupant may then transmit or share the third recording with others or via social media at a user device 302, such as the second occupant's phone or tablet. While two vehicles are illustrated, more may be appreciated. Further, sharing and iterative looping may be possible with a home karaoke system in addition to the vehicle systems shown.

Returning to FIG. 1, the processor 106 may employ various audio processing techniques to facilitate in car communications as well as the karaoke system 200. For example, various filters, compressors, amplifiers, etc., may be applied to the audio signals to increase user satisfaction and facilitate the in-car communications. In some examples, a wake-up word may be spoken during live playback of a singer's voice. In this case the processor 106 may provide in car communications (ICC) for processing without the utterance being affected by voice effects such as reverb that may be applied to the singer's voice. That is, the wake-up word may be detected, as well as the utterance following the wake-up word. The utterance may be received by the microphone 132 and processed for ICC without the application of the voice effects typically applied to karaoke content.

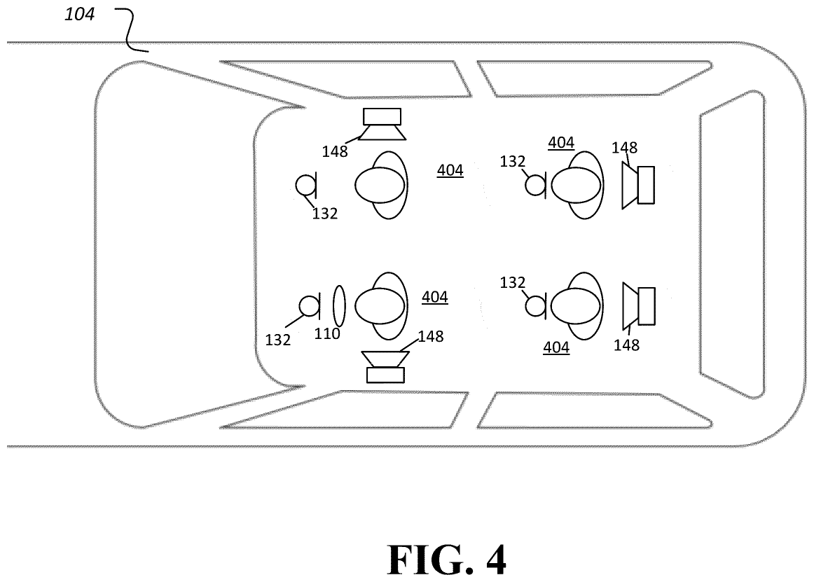

FIG. 4 illustrates an example portion of a multichannel sound system 400 within a vehicle 104. The sound system 400 may have multiple sound zones 404. A sound zone 404 may refer to an acoustic section of the environment in which different audio can be reproduced. To use a vehicle as an example, the environment may include a sound zone 404 for each seating position within the vehicle. While the environment is shown as being a vehicle cabin, the environment may also be a room or other enclosed area such as a concert hall, stadium, restaurant, or auditorium.

The multichannel sound system 400 may include loudspeakers 148 and microphones 132. The processor 106 may receive and transmit signals to and from the loudspeakers 148 and microphones 132 and utilize amplification and reverb or other sound effects to reinforce voice signals captured by the microphones 132 within the multiple sound zones 404. The reinforcement may include localizing the voice signal within the multiple sound zone environment 102, identifying the loudspeakers 148 closest to the person talking, and using that feedback to reinforce the voice output using the identified loudspeakers 148.

Audio signals for the karaoke system may be provided by various audio sources such as any device capable of generating and outputting different media signals including one or more channels of audio. Examples of audio sources may include a media player (such as a compact disc, video disc, digital versatile disk (DVD), or BLU-RAY disc player), a video system, a radio, a cassette tape player, a wireless or wireline communication device, a navigation system, a personal computer, a portable music player device, a mobile phone, an instrument such as a keyboard or electric guitar, or any other form of media device capable of outputting media signals.

In an example, multiple microphones 132 are provided for each sound zone 404 position, so that beam-formed signals can be obtained for each sound zone 404 position. This may accordingly allow the processor 106 to receive a directional detected sound signal for each sound zone 404 position (e.g., if a loudspeaker is detected within the sound zone 404). By using a beam-formed signal, information about whether this is an actively speaking user in each sound zones 404 may be derived. Additional voice activity detection techniques may additionally be used to determine whether a loudspeaker is present, such as changes in energy, spectral, or cepstral distances in the captured microphone signals.

In an example vehicle use case, the processor 106 may support communication between the sound zones 404 via the microphones 132 and loudspeakers 148. For instance, passengers of a vehicle may communicate between the front seats and the rear seats. In such an example, the processor 106 may direct playback via the loudspeakers 148 to other passengers in the vehicle 104.

In another example, passengers of a vehicle may sing karaoke. In such an example, the processor 106 may instruct for playback of a voice of a passenger via the loudspeakers 148 to the same passenger in the vehicle. Further details of an example implementation of karaoke in a vehicle environment are discussed in detail in European Patent EP2018034B1, filed on Jul. 16, 2007, titled METHOD AND SYSTEM FOR PROCESSING SOUND SIGNALS IN A VEHICLE MULTIMEDIA SYSTEM, the disclosure of which is incorporated herein by reference in its entirety.

Returning to FIG. 1, as explained above, the processor 106 may be configured to instruct the light 154 as well as vehicle systems in response to the karaoke content. In one example, the processor 106 may instruct the vehicle lights 154 to alter in response to the content/music. For example, the ambient color lighting may be altered to match the music by flickering to the rhythm, changing color, etc. For instance, the processor 106 may determine loudness of the content being played back and may adjust the intensity and/or color of the light 154 to visualize the differences in loudness. As another possibility, the processor 106 may measure energy of the content being played back in various frequency bands and may adjust the intensity and/or color of the light 154 to visualize the differences in spectral energy. The occupants may select or save settings or preferences associated with the lights. For example, the occupants may opt for a certain color, effect, frequency, etc.

The processor 106 may also control some vehicle systems in order to facilitate karaoke. In one example, the processor 106 may instruct the vehicle windows to be closed in response to an occupant starting to sing so as to not disturb others outside of the vehicle 104. Thus, the processor 106 may be configured to determine whether an audio signal received at the microphone 132 is that of a karaoke signal. This may be done by receiving additional data or signals from other vehicle components, such as the display, indicating the selection of a karaoke. The processor 106 may also be capable of determining whether the audio signals received at the microphones 132 is one including singing, or spoken utterances, etc.

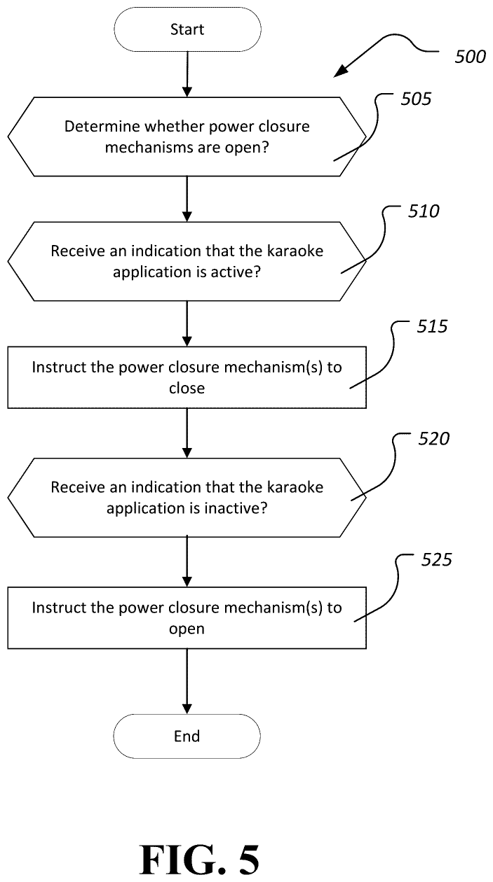

FIG. 5 illustrates an example process 500 for the karaoke system 200. The process 500 may begin at block 505 where the processor 106 is programmed to determine whether one or more openings are open. This may include checking to see if the windows, sunroof, etc. are in an open state. This may be determined based on received status data from the closure mechanisms 162. The status data may indicate whether a window is open or closed. If at least one of the openings is open, the process 500 proceeds to block 510.

At block 510, the processor 106 is programmed to receive an indication that the karaoke system 200 is active. This may be done by receiving data from a vehicle component indicating that a vehicle occupant is using the karaoke application, or that the occupant is signing. This may be done by evaluating the audio signals received by the microphone 132, and/or data from other vehicle devices that would indicate that the occupant is participating in karaoke. If the processor 106 determines that the occupant is participating in karaoke, the process 500 may proceed to block 515.

At block 515, the processor 106 may instruct at least one powered closure mechanism 162 to close an opening in response to the determination that karaoke is taking place. This may avoid embarrassment for the user, or disturbances to persons outside of the vehicle 104. The acoustic environment may also be better understood when the windows or other vehicle openings are closed, allowing for better and more optimal signal processing.

At block 520, the processor 106 may determine whether the karaoke application is inactive. This may be done based on similar triggers as described above to determine whether an occupant is participating in karaoke. For example, the microphone 132 may receive audio signals that indicate speaking voices instead of singing. The vehicle 104 may receive other indications that karaoke has ceased such as a song coming to a stop, or the volume being turned down. If the processor 106 determines that the karaoke has ceased, the processor 106 may proceed to block 520.

At block 525, the processor 106 may instruct the power closure mechanism 162 to reopen or return the opening to the state that the opening was in block 505. The process 500 may then end.

Further, as explained above, all openings that were open, or a subset of the openings, may be closed. In one example, each opening may be associated with a certain seat location or occupant. The processor 106 may control the associated opening based on a determination of who is participating in karaoke. This may be determined based on any number of inputs and signals such as which microphone 132 picks up the occupants' voice, the occupant's mobile device, etc. That way, only the window closest to the singer may close, while others may stay opened. Some openings, such as a sunroof, may close in the event anyone is signing or as soon as the karaoke application 200 is considered active.

While examples are described herein, other vehicle systems may be included and contemplated. Although not specifically shown, the vehicle may include on-board automotive processing units that may include an infotainment system that includes a head unit and a processor and a memory. The infotainment system may interface with a peripheral-device set that includes one or more peripheral devices, such as microphones, loudspeakers, the haptic elements, cabin lights, cameras, the projector and pointer, etc. The head unit may execute various applications such as a speech interface and other entertainment applications, such as a karaoke application. Other processing include text to speech, a recognition module, etc. These systems and modules may respond to user commands and requests.

Computing devices described herein generally include computer-executable instructions, where the instructions may be executable by one or more computing devices such as those listed above. Computer-executable instructions may be compiled or interpreted from computer programs created using a variety of programming languages and/or technologies, including, without limitation, and either alone or in combination, Java™, C, C++, C#, Visual Basic, Java Script, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A system for interactive and iterative media generation, comprising:
loudspeakers configured to play back audio signals into an environment, the audio signals including karaoke content;
at least one microphone configured to receive microphone signals indicative of sound in the environment; and
a processor programmed to
receive a first microphone signal from the at least one microphone, the first microphone signal including a first user sound and karaoke content,
instruct the loudspeakers to play back the first microphone signal,
receiving a second microphone signal from the at least one microphone, the second microphone signal including the first user sound of the first microphone signal and a second user sound,
transmitting the second microphone signal, including the first and second microphone signals and the karaoke content, as an instance of iteratively-generated media content.

2. The system of claim 1, wherein the first microphone signal is received by a first vehicle, and the second microphone signal is transmitted from the first vehicle to another vehicle.

3. The system of claim 1, wherein the second microphone signal is transmitted to a social media platform.

4. The system of claim 1, wherein the second microphone signal is recorded to a computer readable medium for later playback.

5. The system of claim 1, wherein the first user sound is a voice sound.

6. The system of claim 1, wherein the second user sound is a percussion or rhythmic sound created by a user.

7. The system of claim 1, wherein the first microphone sound includes a first vocal track sung by a user, and the second microphone sound includes a second vocal track sung by the user, such that the iteratively-generated media content includes overdubbed vocals of the same user.

8. The system of claim 1, wherein the second microphone signal is overdubbed on the first microphone signal.

9. The system of claim 1, wherein the processor is further programmed to:
apply one or more audio effects to the first microphone signal for playback by the loudspeakers;
identify, in the first microphone signal, an utterance of a wake word; and
provide the first microphone signal for in car communications (ICC) and/or voice assistant functionality without the utterance being affected by voice effects or voice filters that are applied for karaoke.

10. A method for interactive and iterative media generation between vehicles, comprising:
receiving a first microphone signal from at least one microphone at a first vehicle, the first microphone signal including a first user sound and karaoke content;
transmitting the first microphone signal to a second vehicle;
receiving a second microphone signal from the second vehicle, the second microphone signal including the first user sound of the first microphone signal and a second user sound; and
transmitting the second microphone signal, including the first and second microphone signals and the karaoke content, as an instance of iteratively-generated media content.

11. The method of claim 10, wherein the second microphone signal is recorded to a computer readable medium for later playback.

12. The method of claim 10, wherein the first user sound is a voice sound from an occupant of the first vehicle.

13. The method of claim 10, wherein the second user sound is a percussion or rhythmic sound created by an occupant of the second vehicle.

14. The method of claim 10, wherein the first microphone sound includes a first vocal track sung by a user, and the second microphone sound includes a second vocal track sung by the user, such that the iteratively-generated media content includes overdubbed vocals of the same user.

15. The method of claim 10, wherein the second user sound is another voice sound from an occupant within the second vehicle.

16. The method of claim 10, wherein the second microphone signal is overdubbed on the first microphone signal.

17. A system for sound signal processing in a vehicle multimedia system, comprising:
loudspeakers configured to play back audio signals into an environment, the audio signals including karaoke content;
at least one microphone configured to receive microphone signals indicative of sound in the environment;
at least one vehicle opening having a powered closure mechanism; and
a processor programed to
receive a microphone signal from the at least one microphone, and
in response to a determination that the microphone signal includes occupant voice content, instruct the powered closure mechanism to move the at least one vehicle opening to a closed position.

18. The system of claim 17, wherein the processor is programmed to determine the at least one vehicle opening based on a location of an occupant using the karaoke application and wherein the at least one vehicle opening is adjacent to the occupant using the karaoke application.

19. The system of claim 17, further comprising at least one microphone configured to receive microphone signals indicative of sound in the environment, wherein the processor is further programmed to receive a microphone signal from the at least one microphone, and in response to a determination that the microphone signal includes occupant voice content, instruct the powered closure mechanism to move the at least one vehicle opening to the closed position.

20. The system of claim 17, where the processor is further programed to, in response to a determination that karaoke application is inactive, instruct the closure mechanism to move the at least one vehicle opening to an open position.
